(19) United States
(12) Patent Application Publication
(10) Pub. No.: US 2007/0294459 A1
(43) Pub. Date: Dec. 20, 2007

(54) Apparatus for bridging a host to a SAN

(75) Inventor: Jen-kai Chen, Taipei (TW)

Correspondence Address: SUGHRUE MION, PLLC, 2100 PENNSYLVANIA AVENUE, N.W., SUITE 800, WASHINGTON, DC, 20037, US

(73) Assignee: ACARD Technology Corp.

(21) Appl. No.: 11/453,773

(22) Filed: Jun. 16, 2006

(51) Int. Cl. G06F 13/36

(52) U.S. Cl. 710/315

(57) ABSTRACT

The present invention discloses a bridging apparatus for bridging a host to a SAN (Storage Area Network). The bridging apparatus is capable of virtualizing a disk volume allocated in the SAN as a DAS (Direct Attached Storage). The bridging apparatus of the present invention comprises: a first HBA (Host Bus Adapter) for connecting to a SAN, a second HBA for connecting to a host having a DAS interface, a bridge controller for connecting to the first HBA and the second HBA, respectively, so as to bridge the host to the SAN, thereby allowing the host to directly access a disk volume allocated in the SAN, and a storage unit connecting to the bridge controller for storing programs and data.

### FIELD OF THE INVENTION

The present invention relates to a bridging apparatus, particularly to a bridging apparatus for bridging a host to a SAN (Storage Area Network).

### DESCRIPTION OF PRIOR ART

Except for enterprises that have storage area networks, most storages are mainly directed to DAS (Direct Attached Storage). DAS generally refers to the storage device that directly connects to a host (such as a server or desktop computer) with SCSI, SATA (Serial ATA), eSATA (External SATA), USB, SAS (Serial Attached SCSI), etc.

DAS is commonly used in general companies. However, due to limitations of congenital architecture, DAS has the following disadvantages when its storage device directly connects to an application server:
1. The storage device is not shared by several servers;
2. Available linking distance of DAS interface is short so that the storage system cannot be easily expanded; and
3. Remote management and backup are not easy.

Therefore, SAN (Storage Area Network) is developed to be a new generation solution for business storage for overcoming the above disadvantages of DAS.

SAN is primarily used in e-business and enterprise networks, which need large capacity and high-speed storage environments. A SAN normally consists of a fiber channel, server, storage apparatus, fiber switch and hub.

Storage systems in SAN are shared resource for respective servers. FIG. 1 shows general system architecture of SAN, wherein at least one server in SAN is to be a storage initiator. Further, a plurality of storage apparatuses (such as RAID) is connected to SAN to be a storage target for providing storage space.

Although SAN provides advantages in expandability and centralized management, a SAN HBA (Host Bus Adaptor) has to be installed in servers or hosts to be connected with SAN in order to attach the servers and hosts to SAN as said storage initiator, and thereby accessing a SAN volume.

However, servers with SAN HBA are expensive, and fiber switches are expensive, too, such that a general computer system as shown in FIG. 1, i.e., a computer without SAN HBA, may only indirectly connect to SAN through the Ethernet.

So far, IP SAN constructed based on iSCSI protocol and the Ethernet provides a low-cost scheme such that according to different interface types, SAN can be classified into FC SAN with a fiber channel interface and IP SAN with an Ethernet interface. iSCSI is still expensive and its speed is not as fast as a fiber channel, even though the Ethernet provides a low cost. Therefore, IP SAN has not taken the place of FC SAN in an enterprise yet, but is appropriate for middle companies.

Presently, an Ethernet SAN, constructed based on AoE (ATA over Ethernet) and the Ethernet, provides lower cost and merely utilizes a common Ethernet adapter, but is not popularly supported.

Since the cost for SAN is higher than DAS, SAN is generally used in an architecture constructed with a plurality of servers and storage devices, and DAS is usually used in local storage devices of general computers. It provides advantages, such as easy configuration, safe data, easy expansion and centralized management, if SAN can be connected to general computers and the volume of SAN can be virtualized as a storage device of DAS. Therefore, an apparatus and method for rapidly bridging DAS to SAN at a low cost is necessary. The bridging apparatus of the present invention is suitable to be used in FC SAN, IP SAN and Ethernet SAN.

### SUMMARY OF THE INVENTION

The present invention discloses a bridging apparatus for bridging a host to a SAN, and the bridging apparatus is capable of virtualizing a disk volume allocated in the SAN as a DAS. The bridging apparatus comprises: a first HBA for connecting to a SAN, a second HBA for connecting to a host having a DAS interface, a bridge controller for connecting to the first HBA and the second HBA, respectively, so as to bridge the host to the SAN, thereby allowing the host to directly access a disk volume allocated in the SAN, and a storage unit connecting to the bridge controller for storing programs and data.

The bridging apparatus of the present invention provides an advantage of plug-and-play without installing any additional driver.

The bridging apparatus of the present invention provides another advantage that a host attaching to the SAN may directly boot-up from a disk volume of the SAN.

The bridging apparatus of the present invention provides a further advantage that a host attaching to the SAN may directly access a disk volume allocated in the SAN as accessing a local disk.

The bridging apparatus of the present invention provides a further advantage that IT persons may centrally manage disk spaces assigned to hosts attaching to the SAN.

### BRIEF DESCRIPTION OF THE DRAWINGS

FIG. 1 illustrates an architecture of SAN;

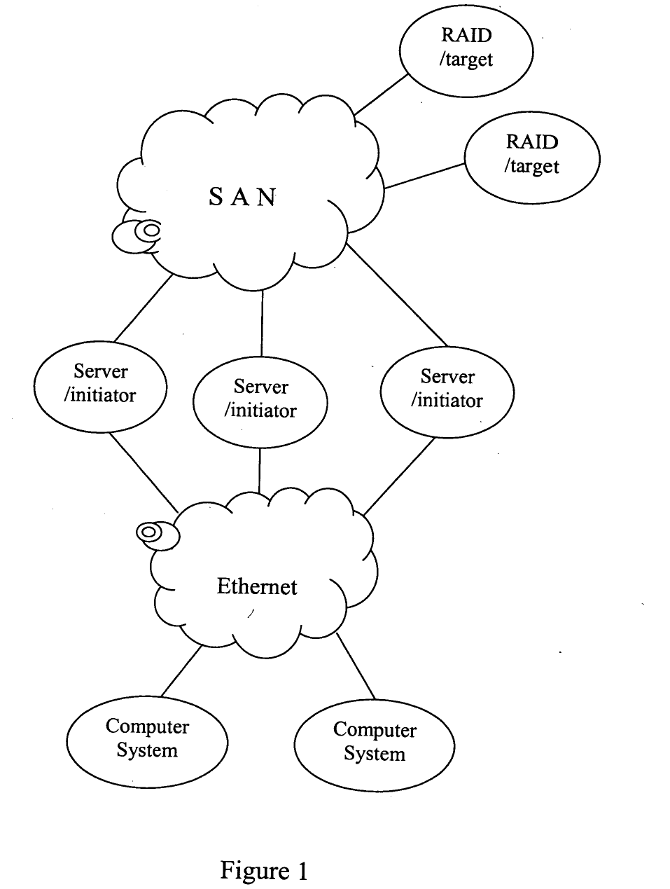

FIG. 2 illustrates a first preferred embodiment of the bridging apparatus of the present invention;

FIG. 3 illustrates a second preferred embodiment of the bridging apparatus of the present invention; and

FIG. 4 illustrates a third preferred embodiment of the bridging apparatus of the present invention.

### DETAILED DESCRIPTION

A preferred embodiment of the present invention is described in detail below. However, the present invention can be widely applied in embodiments other than those described in the detailed description, and the scope of the present invention is not limited by the embodiment, but is defined by the appended claims.

The present invention discloses a bridging apparatus for bridging a host to a SAN, and the bridging apparatus is capable of virtualizing a disk volume allocated in the SAN as a DAS drive. Through a DAS interface, e.g. SCSI, USB, SAS or SATA with support of port multiplier, the host can attach multiple virtual DAS drives simultaneously. The bridging apparatus comprises: a first HBA for connecting to a SAN, a second HBA for connecting to a host having a DAS interface, a bridge controller for connecting to the first HBA and the second HBA, respectively, so as to bridge the host to the SAN, thereby allowing the host to directly access a disk volume allocated in the SAN, and a storage unit connecting to the bridge controller for storing program and data.

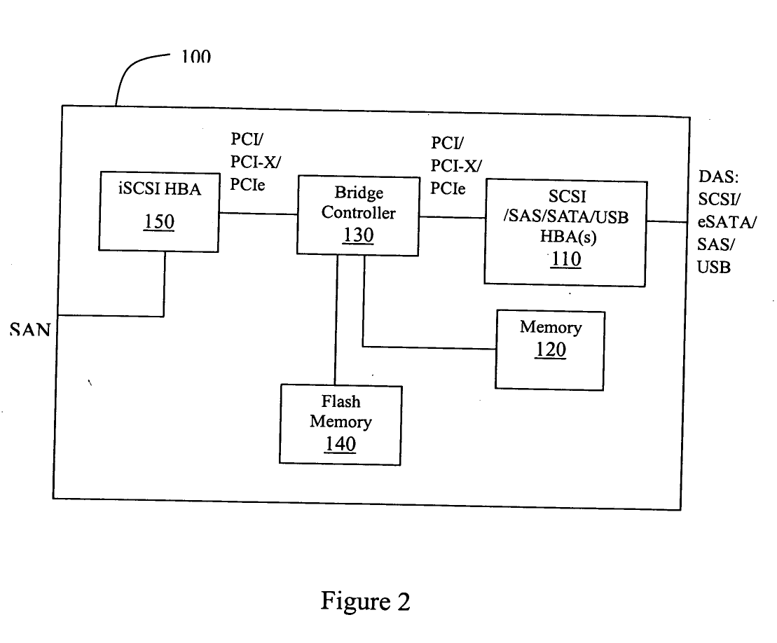

FIG. 2 illustrates a first preferred embodiment of the bridging apparatus of the present invention. The bridging apparatus 100 is used to bridge a virtual DAS to a SAN wherein the bridging apparatus 100 comprises an iSCSI HBA 150 for connecting to an IP SAN, a DAS HBA 110 for connecting to a host having a DAS interface, and a bridge controller 130 for connecting to the iSCSI HBA 150 and the DAS HBA 110, respectively. The host in the embodiment can be a workstation, a laptop computer, a server, a desktop computer or an industrial computer.

The foregoing DAS HBA 110 may connect to one of the SCSI, SATA (Serial ATA), eSATA (External SATA), USB or SAS (Serial Attached SCSI) interfaces. However, persons skilled in the art know that the accomplishment of the present invention should not be limited by the above interfaces.

Further, the bridging apparatus 100 includes a flash memory 140 and a DRAM 120 respectively connecting to the bridge controller 130. The DRAM 120 is used to be a cache memory of the disk volume for the SAN so as to speed up access to the SAN, and the flash memory 140 is used to store programs and data needed by the bridge controller 130.

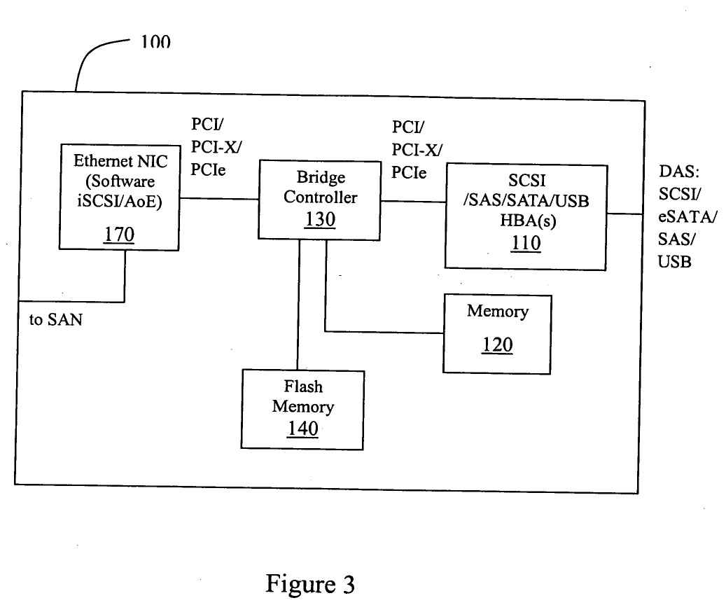

FIG. 3 illustrates a second preferred embodiment of the present invention. The difference between in FIG. 2 and FIG. 3, the iSCSI HBA 150 connecting to the SAN is replaced by an Ethernet NIC 170 (Ethernet Network Interface Card). The Ethernet NIC 170 uses resources of the host to simulate iSCSI or AoE (ATA over Ethernet) protocol by software computing.

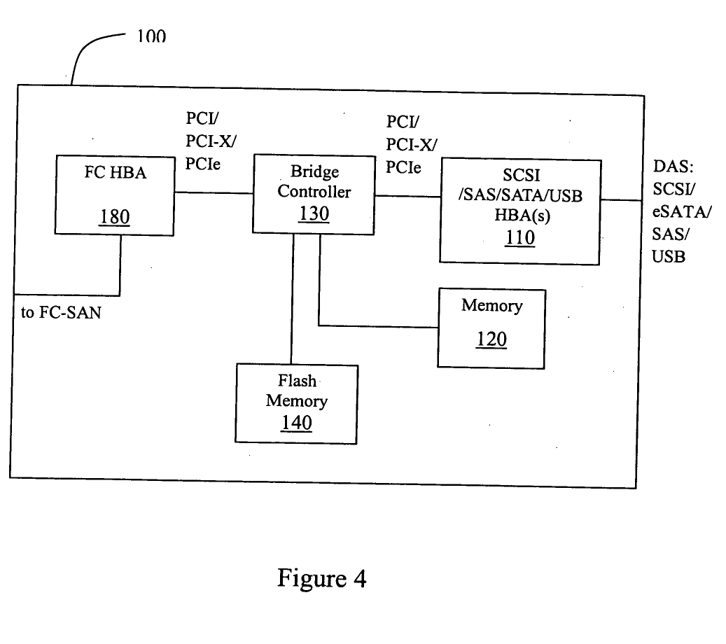

FIG. 4 illustrates a third preferred embodiment of the present invention. The difference between in FIG. 2 and FIG. 4, the iSCSI HBA 150 connecting to the SAN is replaced by an FC HBA 180 (Fiber Channel HBA). In other word, the bridging apparatus of the present invention may connect to a FC SAN via an FC interface.

The bridging apparatus of the present invention may simplify connecting from a DAS to a SAN and provides the following advantages: 1) Plug-and-play without additional driver. 2) Hosts connecting to the SAN may boot-up through a disk volume allocated in the SAN without additional boot ROM. Since a disk volume of the SAN is assigned to a host connecting to the SAN via the bridging apparatus of the present invention, the host may boot-up without any local disk. In fact, the host will deem the disk volume allocated in the SAN as a local disk. 3) Therefore, the host connecting to the SAN may directly access the volume disk allocated in the SAN as accessing a local disk. 4) The host connecting to the SAN via the bridging apparatus of the present invention does not need any local disk. Instead, a storage space in the SAN will be assigned to the host connecting to the SAN, such that IT persons may centralize managing and allocating disk spaces for hosts connecting to the SAN. 5) In addition, the bridging apparatus of the invention may be used in different platforms.

The above description is only a preferred embodiment of the present invention, and not used to limit the claims of the present invention. All equivalent variations or modifications performed without departing from the spirit disclosed in the present invention are within the following claims.

What is claimed is:

1. A bridging apparatus for bridging a host to a SAN, comprising:
a first HBA for connecting to the SAN;
a second HBA for connecting to a host having a DAS interface;
a bridge controller connecting to the first HBA and the second HBA, respectively, for bridging the host to the SAN, thereby allowing the host to directly access a disk volume allocated in the SAN; and
a storage unit connecting to the bridge controller for storing programs and data.

2. The bridging apparatus as claimed in claim 1, wherein the first HBA is an iSCSI interface.

3. The bridging apparatus as claimed in claim 1, wherein the first HBA is a fiber channel interface.

4. The bridging apparatus as claimed in claim 1, wherein the storage unit includes a flash memory and a DRAM in which the DRAM is used to be a cache memory and thereby speed up access to the disk volume of the SAN, and the flash memory is used to store programs and data needed by the bridge controller.

5. The bridging apparatus as claimed in claim 1, wherein the host is a workstation.

6. The bridging apparatus as claimed in claim 1, wherein the host is a laptop computer.

7. The bridging apparatus as claimed in claim 1, wherein the host is a server.

8. The bridging apparatus as claimed in claim 1, wherein the host is a personal computer.

9. The bridging apparatus as claimed in claim 1, wherein the DAS interface is one of the interfaces of SCSI, SATA (Serial ATA), eSATA (External SATA), USB or SAS (Serial Attached SCSI).

10. The bridging apparatus as claimed in claim 1, wherein the first HBA for the SAN and the second HBA for the DAS can be integrated with the bridge controller in a single chip in SoC (System on Chip) implementation.

11. A bridging apparatus for bridging a host to a SAN, comprising:
an HBA for connecting to a host having a DAS interface;
an Ethernet interface card for connecting to the SAN and the Ethernet interface card performing iSCSI or AoE (ATA over Ethernet) protocol by software simulation;
a bridge controller connecting to the HBA and the Ethernet interface card, respectively, for bridging the host to the SAN, thereby allowing the host to directly access a disk volume allocated in the SAN;
a DRAM connecting to the bridge controller for speeding up access to the disk volume of the SAN; and
a flash memory connecting to the bridge controller for storing programs and data needed by the bridge controller.

12. The bridging apparatus as claimed in claim 11, wherein the HBA is an iSCSI interface.

13. The bridging apparatus as claimed in claim 11, wherein the HBA is a fiber channel interface.

14. The bridging apparatus as claimed in claim 11, wherein the host is a workstation.

15. The bridging apparatus as claimed in claim 11, wherein the host is a laptop computer.

16. The bridging apparatus as claimed in claim 11, wherein the host is a server.

17. The bridging apparatus as claimed in claim 11, wherein the host is a desktop personal computer.

18. The bridging apparatus as claimed in claim 11, wherein the host is an industrial computer.

19. The bridging apparatus as claimed in claim 11, wherein the DAS interface is one of the interfaces of SCSI, SATA (Serial ATA), eSATA (External SATA), USB or SAS (Serial Attached SCSI).
